(19) United States
(12) Patent Application Publication
(10) Pub. No.: US 2013/0267228 A1
(43) Pub. Date: Oct. 10, 2013

(54) POSITION SEARCH SYSTEM, A MOBILE INFORMATION TERMINAL, A POSITION SEARCH METHOD AND A RECORDING MEDIUM WHICH RECORDS A POSITION SEARCH PROGRAM

(71) Applicant: Keiichiro Yanagida, Shizuoka (JP)

(72) Inventor: Keiichiro Yanagida, Shizuoka (JP)

(73) Assignee: NEC ACCESS TECHNICA, LTD., Kakegawa-shi, Shizuoka (JP)

(21) Appl. No.: 13/995,699

(22) PCT Filed: Dec. 16, 2011
(86) PCT No.: PCT/JP2011/079967

§ 371 Date: Jun. 19, 2013

(30) Foreign Application Priority Data
Dec. 22, 2010 (JP) 2010-285612

(51) Int. Cl. H04W 4/02

(52) U.S. Cl. CPC H04W 4/028
USPC 455/435.1

(57) ABSTRACT

[Problem]

Even if a mobile information terminal which is the target of the position search exists in the position where it is difficult to acquire the position information by GPS, the information is provided which enables to specify the position of the mobile information terminal.

[Means for Solution]

A mobile information terminal of the present invention comprises a wireless communication means receiving a radio wave from a wireless base station and performing the location registration in said wireless base station, a position information acquisition means acquiring the position information, a storage means storing the position history information that is a set of said position information and the information on said wireless base station at the time when said position information has been acquired, and a control means recording said position history information to said storage means whenever a predetermined fluctuation occurs to said radio wave reception condition.

### TECHNICAL FIELD

The present invention relates to a position search system, a mobile information terminal, a position search method and a position search program for specifying a location of a mobile information terminal.

### BACKGROUND ART

GPS (Global Positioning System) is a system which enables calculating the position of the mobile information terminal and the like based on a radio wave received from a satellite. In recent years, a mobile information terminal equipped with the position information acquisition function by the GPS is widely used. Services are also provided which specify the position of a mobile information terminal in response to inquiry of the position of the mobile information terminal through a network from an apparatus which is remotely located from the mobile information terminal. The technology in relation to the acquisition of the position information on the mobile information terminal has been disclosed as follows.

The patent document 1 discloses a mobile communication terminal apparatus to support for performing the contact in case of emergency more quickly and certainly. The mobile communication terminal apparatus described in the patent document 1 has the following configuration. A position information acquisition means acquires the position information which indicates the present position of the mobile communication terminal apparatus. A position information transmission means can transmit the position information which the position information acquisition means acquires to an external apparatus. A call origination means originates a call which requests the connection with a called communication destination. After the call origination means has originated a call which requests the connection with a called communication destination, a control means automatically informs the position information by making the position information transmission means send the position information. After performing the call origination which requests the connection with a called communication destination, the mobile communication terminal apparatus described in the patent document 1 automatically informs the position information to the person to be notified by sending the position information in advance or afterward. For this reason, even if a user of the mobile communication terminal apparatus cannot have a telephone contact by originating a call, the user can notify his/her own position quickly and certainly.

The patent document 2 discloses a position detection method which can reduce the power consumption further by performing GPS positioning appropriately. The position detection method described in the patent document 2 is a position detection method in which the GPS positioning is performed for the present position every predetermined first period and the positioning result is transmitted to outside through a mobile communications network. In the position detection method of the patent document 2, the communication is carried out to the base station of a mobile communications network every predetermined second period for a standby waiting. According to the communication result, the first period will be made longer when decided as a state of rest in a predetermined range while the first period will be made shorter when decided as a state of moving to outside the predetermined range. According to the position detection method of the patent document 2, the power consumption concerning to the GPS positioning can be reduced appropriately since it is possible to change the interval of the GPS positioning in a state of rest and a state of moving by utilizing the communication result with the base station of a mobile communication network every second period.

The patent document 3 discloses a mobile portable terminal which can always set the channel configuration for the one-segment (one segment broadcasting in the terrestrial digital broadcasting) service and suppress the power consumption of the terminal itself in minimum. The mobile portable terminal in the patent document 3 is a mobile portable terminal which is equipped with a wireless function to communicate with a base station, a one-segment function that receives one segment broadcasting in the terrestrial digital broadcasting and a GPS function to acquire the position information of the user's own terminal. The decision means determines whether the base station area to which the user's own terminal connects has been switched over. The control means carries out a start and a stop of the GPS function according to the determination result of the decision means. The switching means changes the channel configuration of the one-segment radio station corresponding to the position information on the present location obtained by starting the GPS function with the control means. According to the mobile portable terminal on the patent document 3, when the switching of the base station area is detected, the channel setting which is always possible to be watched can be set by acquiring the position information by the GPS function and changing to the channel setting of an appropriate one-segment radio station.

The patent document 4 discloses a mobile apparatus which prevents an owner of the mobile apparatus equipped with the search function from recognizing that operation in which the present position of his/her own apparatus is returned based on a search instruction through the communication network from an external apparatus. The mobile apparatus on the patent document 4 has a search function unit equipped with a control instruction processing unit and a power control unit. The control instruction processing unit deals with a control instruction including a search instruction received from the external apparatus. The power control unit controls a power supply of a mobile apparatus. When the search instruction is received, the control instruction processing unit turns on the power supply of the mobile apparatus by the power control unit in case that the power-supply of the mobile apparatus is off. The control instruction processing unit acquires the present position information of the mobile apparatus as a background job utilizing a gap of the jobs under execution. The control instruction processing unit returns the present position information to the external apparatus. According to the mobile apparatus on the patent document 4, the present position of the lost apparatus can be caught certainly even from a remote location because the apparatus sends the present position of its own apparatus automatically without operating anything for the search instruction from the external apparatus.

### PRIOR ART DOCUMENT

### Patent Document

[Patent Document 1] Japanese Patent Application Laid-Open No. 2005-197820
[Patent Document 2] Japanese Patent Application Laid-Open No. 2006-153695
[Patent Document 3] Japanese Patent Application Laid-Open No. 2009-302691
[Patent Document 4] Japanese Patent Publication No. 4463189

### DISCLOSURE OF THE INVENTION

### Problem to be Solved by the Invention

In the technology disclosed by the patent documents 1 through 4 the position information is acquired by GPS. Therefore, for example, in the patent document 1 or the patent document 4, there is a problem that the position of the terminal can be specified in the environment that the position information cannot be acquired by GPS.

The object of the present invention is to provide a position search system, a mobile information terminal, a position search method and a position search program which enable specifying the existence position of the mobile information terminal when the mobile information terminal exists in the position where it is difficult to acquire the position information by GPS.

### Means for Solving the Problem

A mobile information terminal according to the present invention includes a wireless communication means which receives a radio wave from a wireless base station and performs the location registration in said wireless base station, a position information acquisition means which acquires the position information, a storage means which stores the position history information that is a set of said position information and the information of said wireless base station at the time when said position information has been acquired, and a control means which records said position history information to said storage means whenever a predetermined fluctuation occurs to said radio reception condition.

A position search system according to the present invention is equipped with a mobile information terminal which includes a wireless communication means which receives a radio wave from a wireless base station and performs the location registration in said wireless base station, a position information acquisition means which acquires the position information, a storage means which stores the position history information that is a set of said position information and the information of said wireless base station at the time when said position information has been acquired, and a control means which records said position history information to said storage means whenever a predetermined fluctuation occurs to said radio reception condition, and a position search apparatus that acquires said position history information from said the mobile information terminal and indicates the history of the position of said the mobile information terminal so that it is visually recognizable based on said position history information.

A position search method according to the present invention receives a radio wave from a wireless base station, performs the location registration in said wireless base station, stores the position history information that is a set of said position information and the information of said wireless base station at the time when said position information has been acquired, and records said position history information in said storage means whenever a predetermined fluctuation occurs to said radio wave reception condition.

A recording medium which records a position search program according to the present invention makes a computer execute the processing to receive a radio wave from a wireless base station, the processing to perform the location registration in said wireless base station and to store the position history information which is a set of said position information and the information on said wireless base station at the time when said position information has been acquired, and the processing to record said position history information to said storage means whenever a predetermined fluctuation occurs to said radio reception condition.

### Effect of the Invention

According to the present invention, the information can be provided so as to enable specifying the existence position of the mobile information terminal when the mobile information terminal exists in the position where it is difficult to acquire the position information by GPS.

### BRIEF DESCRIPTION OF THE DRAWINGS

FIG. 1 is a figure which shows the composition of a position search system in the first embodiment of the present invention.

FIG. 2 is a figure which shows the composition of the mobile telephone terminal 100 in the first embodiment of the present invention.

FIG. 3 is a figure which shows a position history information table 41 in the first embodiment of the present invention.

FIG. 4 is a figure which illustrates the change in receiving condition for radio wave 203 and radio wave 401 accompanied with movement of the mobile telephone terminal 100 in the first embodiment of the present invention.

FIG. 5 is a flowchart which shows the operation in which the mobile telephone terminal 100 records the position history information in the position search system in the first embodiment of the present invention.

FIG. 6 is a flowchart which shows the operation in which a position search apparatus 300 in the first embodiment of the present invention acquires the position of the mobile telephone terminal 100.

FIG. 7 is a figure which shows an example of a time sequence data of the position history information in the first embodiment of the present invention.

FIG. 8 is a figure which shows an example of a time sequence data of the position history information in the first embodiment of the present invention.

FIG. 9 is a figure which shows the composition of the mobile information terminal 1000 in the second embodiment of the present invention.

FIG. 10 is a flowchart which shows an operation in the second embodiment of the present invention.

### MODE FOR CARRYING OUT THE INVENTION

A position search system according to the embodiment of the present invention will be described below with reference to the attached drawings.

### First Embodiment

[Description of Configuration]

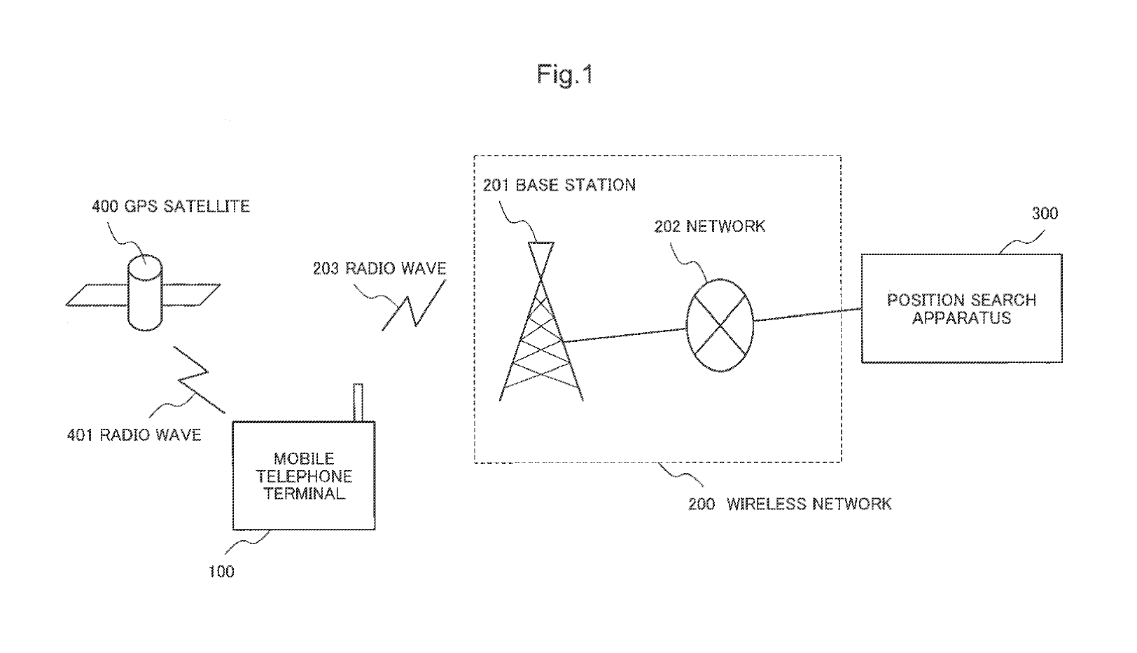

First, the configuration of the position search system in the first embodiment will be described. FIG. 1 is a figure which shows the composition of the position search system in the first embodiment. The position search system of the first embodiment includes the mobile telephone terminal 100, a wireless network 200 and a position search apparatus 300.

The wireless network 200 is constituted in which a base station 201 and a network 202 are connected. The position search apparatus 300 is connected to the network 202. The mobile telephone terminal 100 is connected to the wireless base station 201 via the radio wave 203. The position search apparatus 300 can communicate via mobile telephone terminal 100 and the wireless network 200. Further, each of the base station 201 and the mobile telephone terminal 100 in FIG. 1 is indicated as only one among others which exist with a lot of quantity.

The mobile telephone terminal 100 receives the radio wave 401 transmitted from a GPS satellite 400. The mobile telephone terminal 100 can calculate the position information of the mobile telephone terminal 100 by GPS. The mobile telephone terminal 100 acquires the base station information from the base station 201. The mobile telephone terminal 100 stores the position history information which is a set of the position information and the base station information. As for the position history information, the position information and the base station information, they will be described later. Further, according to the first embodiment, although the mobile telephone terminal 100 has been described as an example, such mobile information terminal is widely applicable as illustrated in a PHS (Personal Handy phone System) and a PDA (Personal Digital Assistants) equipped with the similar function.

The position search apparatus 300 is an apparatus for searching for the position of the mobile telephone terminal 100. The position search apparatus 300 transmits a station acquisition request to the mobile telephone terminal 100 and acquires the position history information from the mobile telephone terminal 100. The position search apparatus 300 is equipped with a display apparatus. The position search apparatus 300 indicates the position of the mobile telephone terminal 100 so that it is visually recognizable based on the acquired position history information.

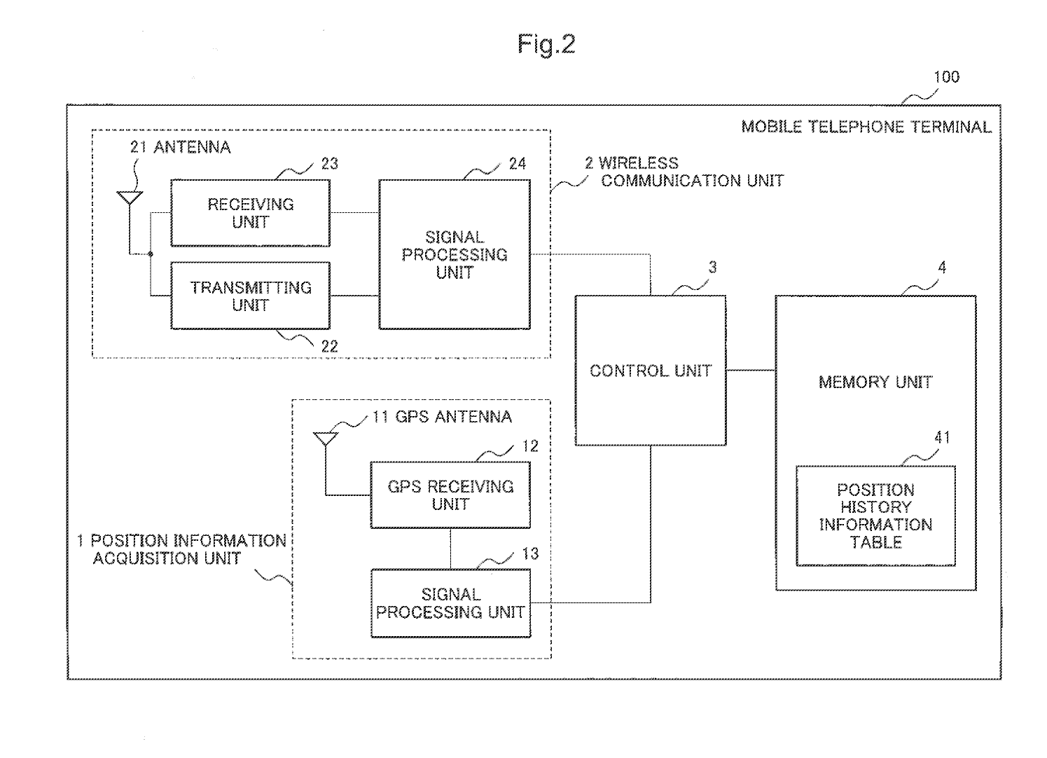

Next, the configuration of the mobile telephone terminal 100 will be described. FIG. 2 is a figure which shows the composition of the mobile telephone terminal 100 in the first embodiment. The mobile telephone terminal 100 of the first embodiment includes the position information acquisition unit 1, a wireless communication unit 2, a control unit 3 and a memory unit 4.

First, the position information acquisition unit 1 includes a GPS antenna 11, a GPS receiving unit 12 and a signal processing unit 13. The GPS antenna 11 receives radio wave 401 from the GPS satellite 400. The GPS receiving unit 12 acquires the received data by executing the receiving operation on the received signal. The signal processing unit 13 acquires the position information by the calculation based on the received data. The Latitude, longitude and altitude information of the mobile telephone terminal 100 and the acquisition time when the position information has been acquired are included in the position information.

Next, the wireless communication unit 2 includes an antenna 21, a transmitting unit 22, a receiving unit 23 and a signal processing unit 24. The antenna 21 receives the radio wave 203 from the base station 201 and transmits the radio wave 203 to the base station 201. The transmitting unit 22 modulates the transmission data from the signal processing unit 24 and outputs the transmission signal to the antenna 21. The receiving unit 23 demodulates the reception signal from the antenna 21 and outputs the received data to the signal processing unit 24. The signal processing unit 24 performs the predetermined signal processing.

When the power of the mobile telephone terminal 100 is turned on, the wireless communication unit 2 performs the reception level measurement of the radio wave 203 received from a plurality of surrounding base stations 201. The wireless communication unit 2 selects a base station 201 which is capable of the wireless communication in the best out of the plurality of base stations 201 and performs the location registration. The mobile telephone terminal 100 performs the wireless communication using the base station 201 of which the location registration has been performed. Further, the base station 201 which is capable of the wireless communication in the best is generally a base station with the highest receiver level of the radio wave 203.

The wireless communication unit 2 continues to measure the reception level of the radio wave 203 received from the plurality of base stations 201 at the predetermined timing after that and updates the base station 201 which is capable of the wireless communication in the best. As a result, the wireless communication unit 2 performs the location registration to the base station which can always perform the fine wireless communication.

Next, the control unit 3 performs the function of the mobile telephone terminal 100. As the control unit 3, for example, it is mentioned to use CPU (Central Processing Unit). Whenever the control unit 3 monitors the radio wave 203 which the wireless communication unit 2 receives, and the predetermined fluctuation occurs to the radio wave 203, the position history information which is the set of the position information and the base station information is recorded to the memory unit 4. The control unit 3 acquires the position information from the position information acquisition unit 1. The control unit 3 acquires the base station information from the wireless communication unit 2. The base station information is the information on the base station 201 of which the wireless communication unit 2 is performing the location registration. The base station information includes the identifier of the base station 201 of which the wireless communication unit 2 is performing the location registration and the reception level of the radio wave 203 received from the base station 203.

The following three cases are included in a predetermined fluctuation of the radio wave 203. The first is the case that a fluctuation which is equal to or larger than the predetermined value occurs to the reception level of the radio wave 203. The second case is that the base station 201 of which the wireless communication unit 2 is performing the location registration has been changed. The third case is that the power of the mobile telephone terminal 100 is turned on, and the wireless communication unit 2 selects the base station 201 which is capable of the wireless communication in the best out of the plurality of base stations 201 and performs the location registration. In each of these three cases, the position of the mobile telephone terminal 100 is considered to have moved. By recording the position history information, which is triggered by the fact that the predetermined fluctuation of the radio wave 203 by which mobile telephone terminal 100 is considered to have moved is occurred, the control unit 3 can record the position history associated with the movement of the mobile telephone terminal 100.

Further, when the position information acquisition unit 1 cannot acquire the position information, the control unit 3 records only the base station information to the memory unit 4 as the position history information. The case that the position information acquisition unit 1 cannot acquire the position information is, for example, a case that it is not possible to calculate the position information because the position information acquisition unit 1 cannot receive the radio wave 401. In this case, it is desirable that the position history information is recorded so that it is distinguishable that the position information could not be acquired.

Next, the memory unit 4 stores a computer program and the data which are needed in order to realize the function of the mobile telephone terminal 100. For example, the memory unit 4 is a non-volatile memory such as a flash memory and the like. The memory unit 4 is equipped with a position history information table 41. The position history information table 41 stores the position history information which is the set of the position information and the base station information.

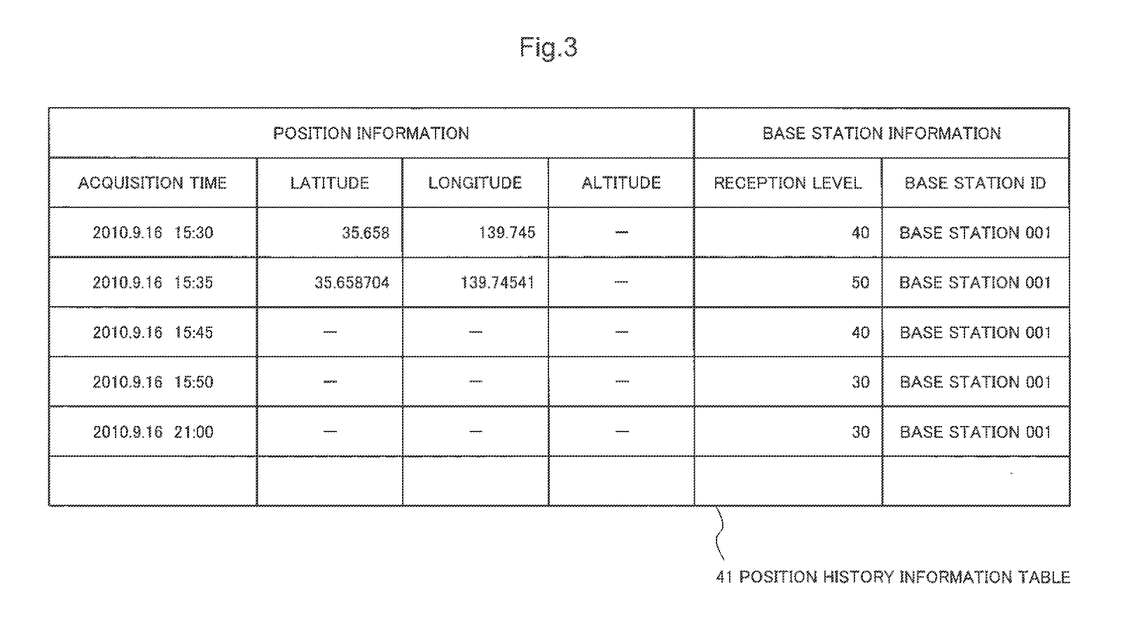

FIG. 3 is a figure which shows the position history information table 41 in the first embodiment. The position history information table 41 has recorded the set of the position information and the base station information in the time sequence order as the position history information. As mentioned above, the position information includes the information on the latitude, longitude and altitude of the mobile telephone terminal 100 and the acquisition time when the position information has been acquired. The base station information includes an identifier of the base station 201 in which the wireless communication unit 2 has performed the location registration and the reception level of the radio wave 203 received from the base station 201 in the acquisition time when the position information has been acquired. Further, the position history information table 41 does not always need to store the position history information in the time sequence order.

Referring to FIG. 3, in the position history information which has been recorded in the position history information table 41, exists the data in which only the value of the base station information is recorded and the value of the position information is a blank space. In FIG. 3, when the acquisition time is “2010.9.16 15:45”, “2010.9.16 15:50” and “2010.9.16 21:00”, the position information has become a blank space. It is shown that when the position information has been acquired, the position information acquisition unit 1 has been in the state that the position information cannot be acquired. In this way, the control unit 3 has made it distinguishable that the position information could not be acquired, and records the position history information when the position information acquisition unit 1 cannot acquire the position information. Further, the method to record, instead of the blank space, the optional flag which can distinguish that the position information cannot be acquired may be employed.

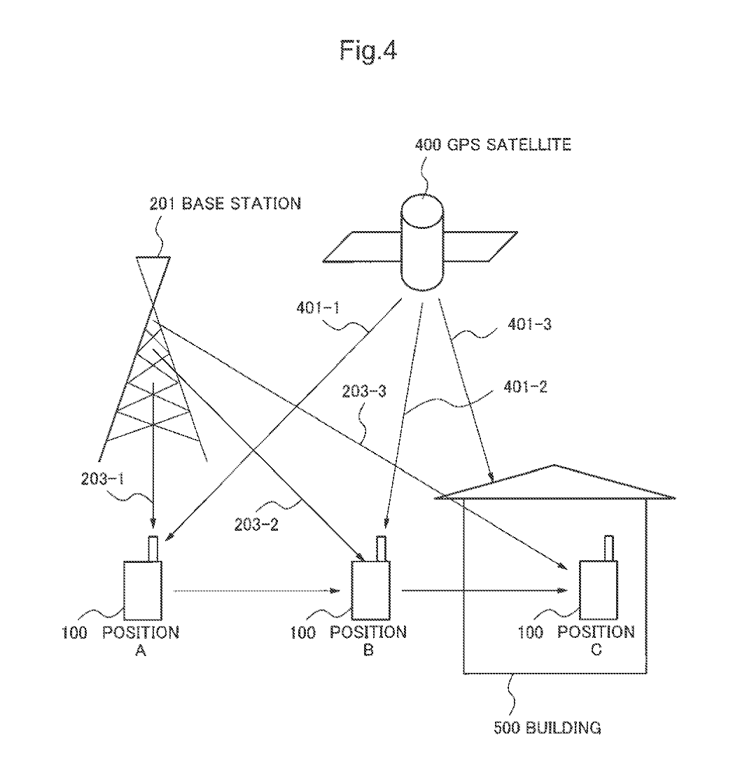

Here, the relation between the movement of the mobile telephone terminal 100 and the record contents of the position history information will be described using FIG. 4. FIG. 4 is a figure which illustrates the change of the receiving condition of the radio wave 203 and the radio wave 401 accompanied with the movement of the mobile telephone terminal 100 in the first embodiment.

First, the mobile telephone terminal 100 exists at the position A. In the position A mobile telephone terminal 100 can receive the radio wave 401-1 from the GPS satellite 400. For example, it is supposed that the mobile telephone terminal 100 is turned on at the position A. The control unit 3 records the position information based on the radio wave 401-1 and the base station information based on the radio wave 203-1 from the base station 201 as the position history information, which is triggered by the fact that the location registration to the base station 201 is completed after the turning-on of the power supply.

Next, the mobile telephone terminal 100 moves to the position B. The distance of the mobile telephone terminal 100 from the base station 201 increases. The radio wave 203-2 from the base station 201 which the mobile telephone terminal 100 receives decreases in the reception level compared with the case of receiving the radio wave 203-1 at the position A. In the position B, the mobile telephone terminal 100 can receive the radio wave 401-2 from the GPS satellite 400. The mobile telephone terminal 100 records the position information based on the radio wave 401-2 and the base station information based on the radio wave 203-2 from the base station 201 as the position history information if the decrease of the radio wave reception level of the radio wave 203-2 is equal to or larger than the predetermined value. In this case, the lower value of the radio wave reception level of the base station information compared with that of the position A is recorded.

Next, the mobile telephone terminal 100 moves to the position C. The position C is inside a building 500. The reception level of radio wave 203-3 from the base station 201 falls to less than that of radio wave 203-2 in the position B. Further, in the position C, the mobile telephone terminal 100 cannot receive the radio wave 401-3 from the GPS satellite. When the decline of the radio wave reception level of the radio wave 203-3 is equal to or larger than the predetermined value, the mobile telephone terminal 100 records the position history information. At that time, the position information acquisition unit 1 is not possible to receive the radio wave 401-3, and cannot calculate the position information. Therefore, in the position history information table 41, the acquisition time of the position information and the base station information based on the radio wave 203-2 from the base station 201 are recorded and the information on the latitude, longitude and altitude remains as a blank column. In this case, the lower value of the radio wave reception level of the base station information compared with the position A is recorded.

Further, for example, it is supposed that another base station 201 has been installed inside the building 500. When determining that the communication with the in-house base station 201 is better, the mobile telephone terminal 100 changes the destination in the location registration to the in-house base station 201. The change of the destination in the location registration of the base station 201 triggers the mobile telephone terminal 100 recording the position history information. At that time, the position information acquisition unit 1 cannot receive the radio wave 401-3, and cannot calculate the position information. Therefore, in the position history information table 41, the acquisition time of the position information and the base station information based on the radio wave 203 from the in-house base station 201 are recorded and the information on the latitude, longitude and altitude remains as a blank column.

In this way, by recording the position history information, which is triggered by the fact that a predetermined fluctuation of the radio wave 203 in which the mobile telephone terminal 100 has been considered to move is occurred, the history of the position corresponding to the movement of the mobile telephone terminal 100 can be recorded. By recording only the base station information when the radio wave 401 from the GPS satellite 400 cannot be received, it can be left in record as the history that it has stayed in the location where the radio wave 401 cannot be received. The above is the description of the configuration of the position search system in the first embodiment.

[Description of Operation]

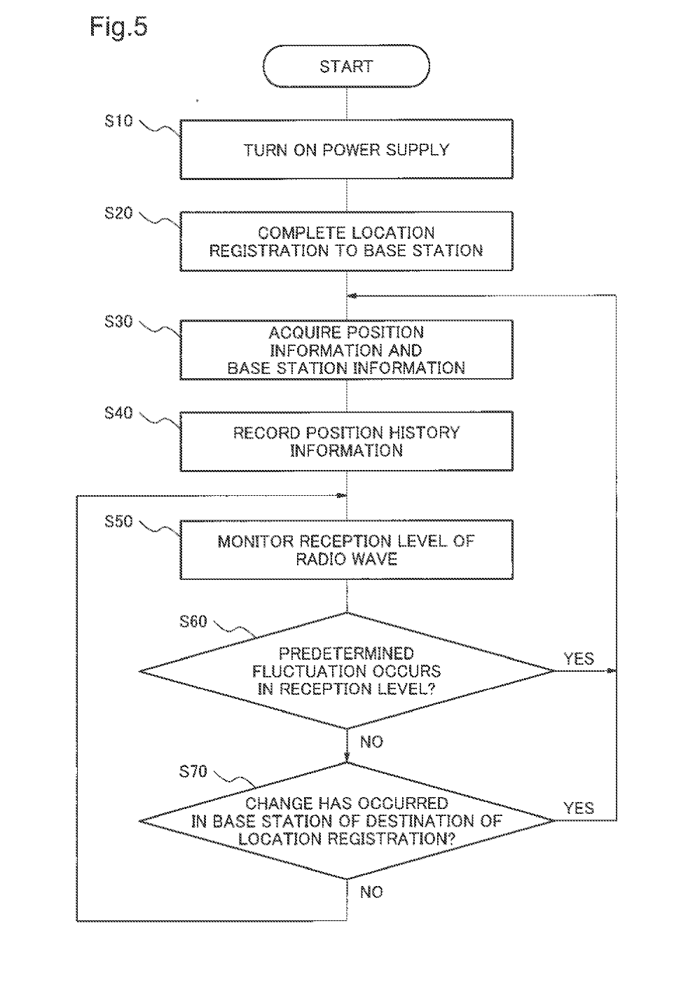

Next, the operation of the position search system in the first embodiment will be described. FIG. 5 is a flowchart which shows the operation in which the mobile telephone terminal 100 records position history information, in the position search system in the first embodiment.

First, the power of the mobile telephone terminal 100 is turned on (Step S10). The wireless communication unit 2 receives the radio wave 203 in the base station 201. The wireless communication unit 2 selects the base station 201 which is capable of providing the communication in the best. The wireless communication unit 2 completes the location registration to the base station 201 (Step S20).

The control unit 3 detects the completion of the location registration by the wireless communication unit 2. The control unit 3 acquires the position information from the position information acquisition unit 1 and the base station information from the wireless communication unit 2 (Step S30), which is triggered by the fact that the completion of location registration is completed. The control unit 3 records the set of the position information and the base station information to the position history information table 41 of the memory unit 4 as the position history information (Step S40).

After that, the control unit 3 monitors the reception level of the radio wave 203 in the wireless communication unit 2 (Step S50). The control unit 3 determines whether a predetermined fluctuation which occurs in the reception level of the radio wave 203 (Step S60). When the predetermined fluctuation has occurred to the reception level (Yes of Step S60), the flow returns to Step S30. In this case, the control unit 3 shifts to the acquisition of the position information and the base station information. On the other hand, when the predetermined fluctuation does not occur to the reception level (No of Step S60), the flow goes towards Step S70.

The control unit 3 determines whether the change has occurred in the wireless base station 201 which is the destination in the location registration by the wireless communication unit 2 (Step S70). When the change occurs in the wireless base station 201 which is the destination in the location registration (Yes of Step S70), the flow returns to Step S30. In this case, the control unit 3 shifts to the acquisition of the position information and the base station information. On the other hand, when the change does not occur in the wireless base station 201 which is the destination in the location registration (No of Step S70), the flow returns to Step S50. In this case, the control unit 3 continues to monitor the reception level of the radio wave 203.

Further, the order of Step S60 and Step S70 does not matter. The following conditions other than the above-mentioned may be added to the trigger with which the position history information is recorded by the control unit 3. One of them is the case that the instruction has been inputted by the user of the mobile telephone terminal 100. Another one is the case that the instruction has been inputted from the outside by an operating person or the like of a position search apparatus 300 and a wireless communication network 200.

In the operation flow mentioned above, the operation according to this flowchart ends when the mobile telephone terminal 100 is turned off. And when it is turned on again, the operation resumes from Step S10. Even if the mobile telephone terminal 100 is turned off, the position history information recorded in the position history information table 41 of the memory unit 4 is held. The position history information is being added into the position history information table 41 after the mobile telephone terminal 100 is turned on again.

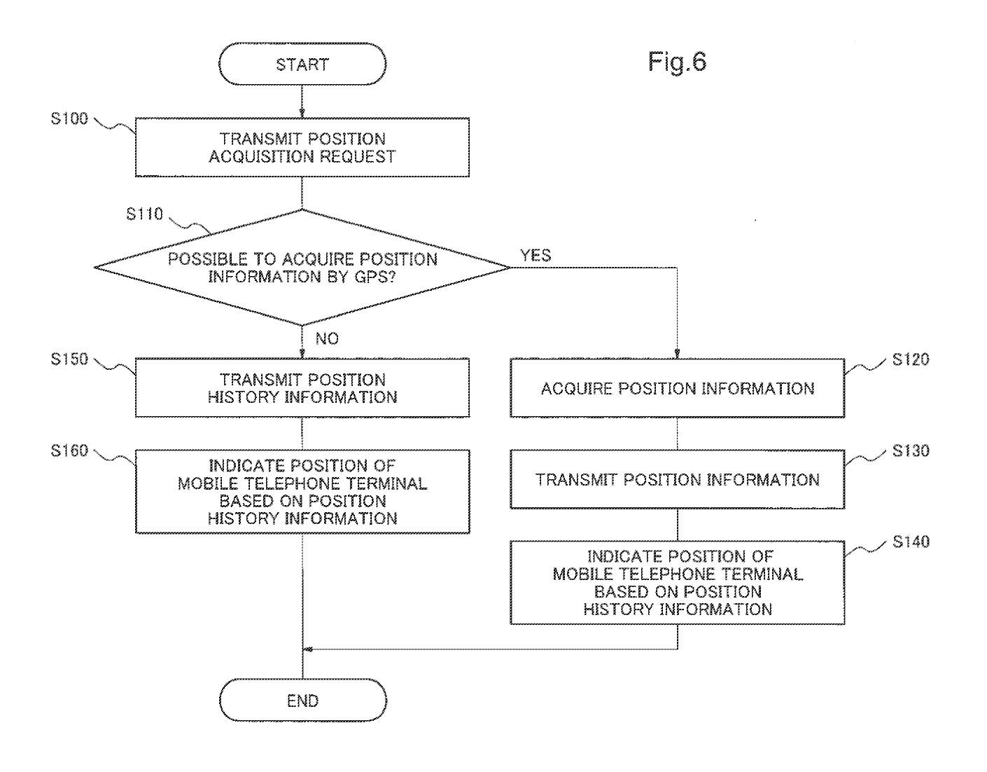

Next, the operation will be described that the position search apparatus 300 in the first embodiment acquires a time sequence data of the position history information from the mobile telephone terminal 100. FIG. 6 is a flowchart which shows the operation in which the position search apparatus 300 in the first embodiment acquires the position of the mobile telephone terminal 100.

First, the position search apparatus 300 transmits a station acquisition request to the mobile telephone terminal 100 via the wireless communication network 200 (Step S100). The mobile telephone terminal 100 receives the station acquisition request. When the station acquisition request is inputted, the control unit 3 of the mobile telephone terminal 100 determines whether the position information acquisition unit 1 can acquire the position information by GPS (Step S110).

When the position information according to GPS can be acquired (Yes of Step S110), the control unit 3 acquires the position information from the position information acquisition unit 1 (Step S120). The control unit 3 transmits the position information to the position search apparatus 300 via the wireless communication network 200 (Step S130). This is because that when the present position information according to GPS can be acquired, responding the present position information according to GPS leads to the most precise indication of the position of the mobile telephone terminal 100. When the position information is received, the position search apparatus 300 indicates the position of the mobile telephone terminal 100 so that it is visually recognizable based on the information on the latitude, longitude and altitude included in the position information (Step S140). The visually recognizable indication means, for example, to put the mark on the position corresponding to the position information on a map with the position search apparatus preparing the map data which is capable of indicating the position corresponding to the information on the latitude, longitude and altitude.

On the other hand, when the position information according to GPS cannot be acquired (No of Step S110), the control unit 3 acquires the position history information from the position history information table 41 of the memory unit 4 and transmits it to the position search apparatus 300 (Step S150). At that time, the control unit 3 transmits the position history information as the time sequence data which is arranged in the time sequence order. Further, the position history information may be arranged in the time sequence order at the moment of recording in the position history information table 41 or the control unit 3 may transmit it after rearranging the position history information in the time sequence order. In addition, the position history information may be rearranged in the time sequence order at the side of the position search apparatus 300. When receiving the time sequence data of position history information, the position search apparatus 300 indicates it so that the movement history of the mobile telephone terminal 100 can be visually recognized based on the time sequence data of the position history information (Step S160). As a result, even if the present precise position of the mobile telephone terminal 100 cannot be acquired, the indicated movement history will become the information for specifying the present position of the mobile telephone terminal 100. Further, the control unit 3 may transmit it to the position search apparatus whenever the position history information is acquired instead of responding to the request of the position search apparatus 300. The above is the description of the operation of the position search system in the first embodiment.

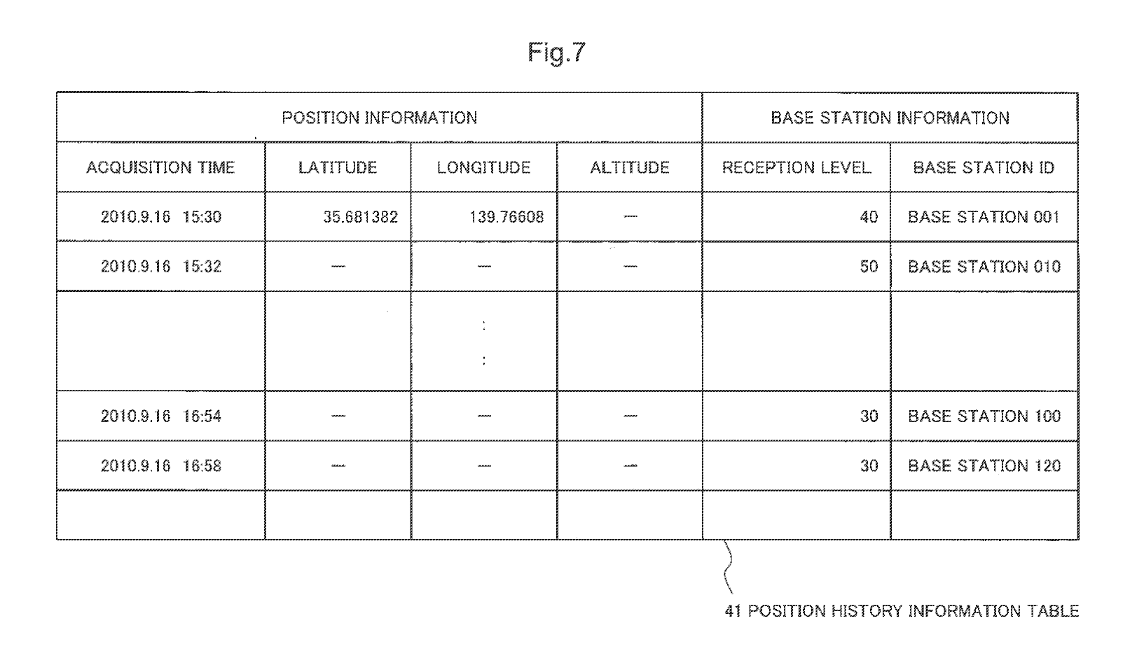

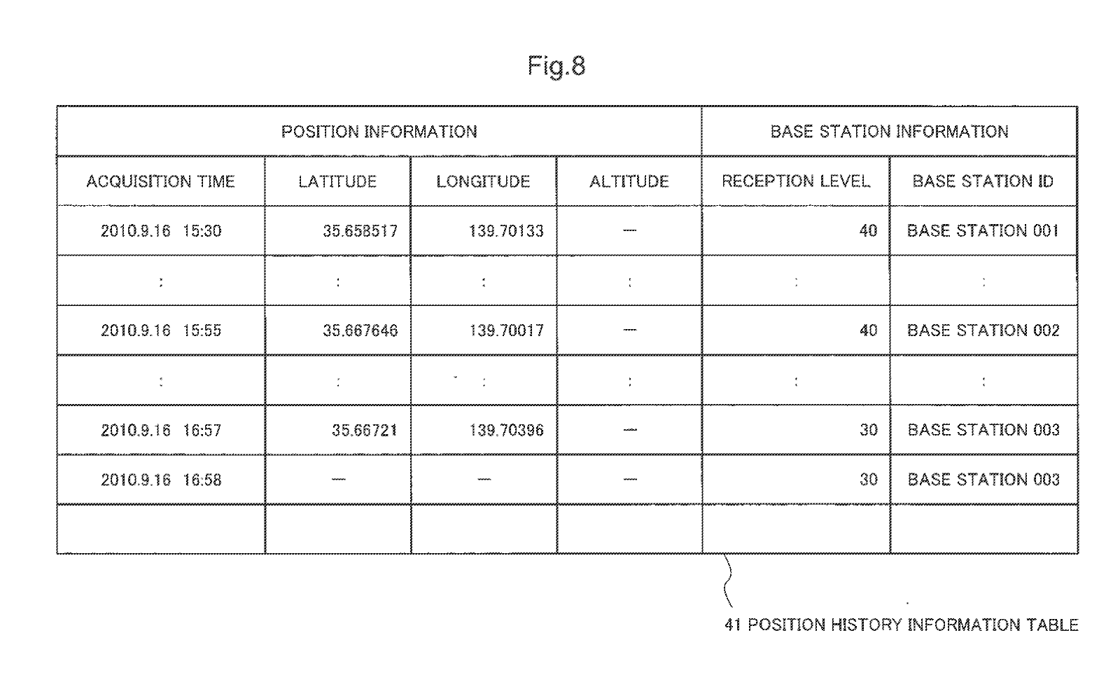

Next, it will be described how to specify the present position of the mobile telephone terminal 100 using a concrete time sequence data of the position history information. FIG. 7 and FIG. 8 are the figures which show an example of the time sequence data of the position history information in the first embodiment.

In FIG. 7, it is supposed that the mobile telephone terminal 100 has received a station acquisition request just after “2010.9.16 16:58”. Referring to FIG. 7, the position information according to GPS cannot be acquired any more after “2010.9.16 15:30” is acquired. Further, the base station identifier of the base station information is changed in each of position history information. As a result, it is comprehended that the mobile telephone terminal 100 is moving in a considerable high speed. For example, the case is considered that the mobile telephone terminal 100 is lost. It is supposed that the position information measured at “2010.9.16 15:30” indicates the station position of the train which runs in a high speed as the new bullet train. According to the high moving speed after that, it can be inferred that the mobile telephone terminal 100 is left in the car of the bullet train. More concretely, the actual train can be specified based on the acquisition time of the last position information, or the site location of the base station 201 with each base station identifier and the time when the reception level of the base station 201 has been measured.

Next, it is supposed that the mobile telephone terminal 100 has received a station acquisition request just after “2010.9.16 16:58” in FIG. 8. Referring to FIG. 8, the position information cannot be acquired at “2010.9.16 16:58”. However, it is possible to check the acquisition of the position information just before. Further, the acquisition time of the position information is obtained with a certain time interval. In addition, the base station identifier of the base station information does not change so much. Hence, it can be guessed that the mobile telephone terminal 100 is moving at a slow speed. For example, the case when the mobile telephone terminal 100 has been lost is considered. When the mobile telephone terminal 100 which has been lost is being moved slowly in a downtown, the possibility can be considered that the mobile telephone terminal 100 has been stolen.

In this way, the mobile telephone terminal 100 records the set of the position information and the base station information as the position history information in the position search system of the present invention. As for the position history information, the base station information is recorded even if the position information cannot be acquired. Therefore, even if the present position information of the mobile telephone terminal 100 cannot be acquired, the present position of the mobile telephone terminal 100 can be specified by using the time sequence data of the position history information auxiliary.

For example, by the position information and the base station information recorded in the position history information, it can be judged whether the mobile telephone terminal 100 is moving or is not moving. When it is moving, it is possible to roughly find the movement direction and the moving speed. In addition, it is possible to specify the location and time at which the position information has been acquired most recently. The user who has lost a mobile telephone terminal 100 can specify the location where the mobile telephone terminal 100 has been lost with taking this information into account. Even in a case that the mobile telephone terminal 100 is located in a place such as a building, an underground or a tunnel, it is possible to specify the rough position from the history of the base station location registered. In this way, the effect is revealed in the position specification when a mobile telephone terminal 100 is lost, and the position information announcement at the time of emergency notification.

Further, in the position specification system of the present invention, the position history information is recorded, which is triggered by the case where the mobile telephone terminal 100 is regarded having moved. Therefore, the power consumption can be suppressed in comparison with the case that the position information is acquired with a constant interval. In order to measure the receiving timing of the GPS signal, there needs no special circuit to be added.

### Second Embodiment

Hereinafter, the second embodiment of the present invention will be described with reference to drawings.

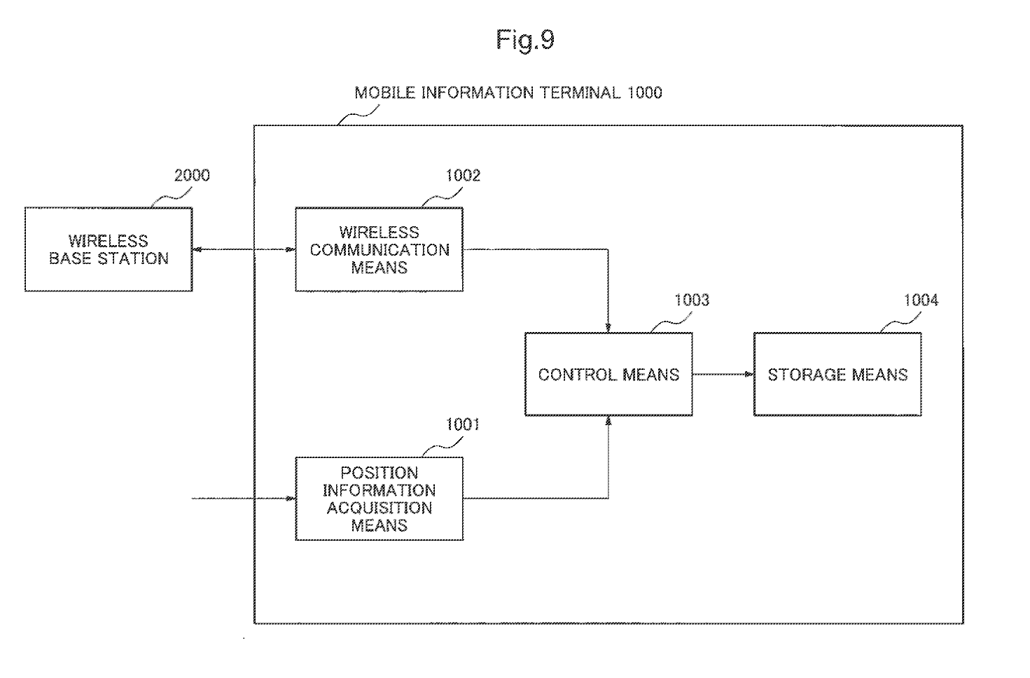

First, FIG. 9 is a figure which indicates a mobile information terminal 1000 according to the second embodiment. According to FIG. 9, the mobile information terminal 1000 connects with a wireless base station 2000. The mobile information terminal 1000 includes a position information acquisition means 1001, a wireless communication means 1002, a control means 1003 and a storage means 1004.

The wireless communication means 1002 receives the radio wave from the wireless base station 2000. The wireless communication means 1002 performs the location registration to the wireless base station 2000.

The position information acquisition means 1001 acquires the position information on the mobile information terminal 1000.

The storage means 1004 stores the position history information which is the set of the position information and the information on the wireless base station 2000 at the time when the position information has been acquired.

Whenever a predetermined fluctuation occurs to the receiving condition for the radio wave received from the wireless base station 2000, the control means 1003 records the position history information in the storage means 1004.

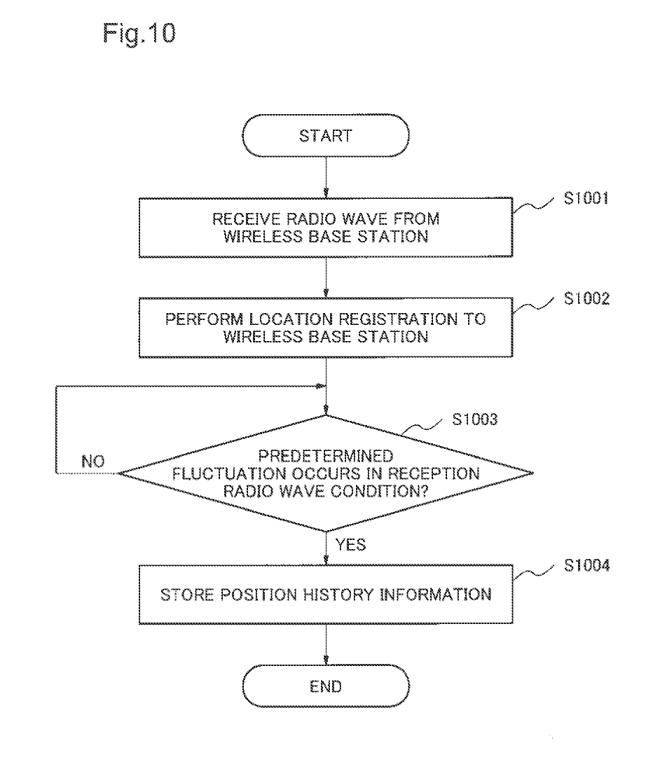

Next, FIG. 10 is a flowchart which indicates the operation according to the second embodiment.

First, the wireless communication means 1002 receives the radio wave from the wireless base station 2000 (S1001).

Next, the wireless communication means 1002 performs the location registration for the wireless base station 2000 (S1002).

Next, the control means 1003 determines whether the predetermined fluctuation has occurred to the receiving condition of the radio wave received from the wireless base station 2000 (S1003).

When the predetermined fluctuation has occurred to the receiving condition of the radio wave, the control means 1003 stores the position history information in the storage means 1004 in S1003 (S1004).

As described above, the position history information, which is the set of the position information and the wireless base station when the position information has been acquired in the case that a predetermined fluctuation has occurred to the receiving condition of the radio wave, is stored according to the second embodiment. Hence, even if the mobile information terminal exists in the position where it is difficult to acquire the position information by the GPS, it is possible to specify the existence position of the mobile information terminal since the information of the wireless base station is stored according to the second embodiment.

### Other Embodiment

A mobile information terminal according to another embodiment of the present invention includes a wireless communication unit which receives a radio wave from a wireless base station, a position information acquisition unit that acquires the position information by GPS (global positioning system), a memory unit which stores the position history information that is a set of the position information and the wireless base station information and a control unit which records the position history information to the memory unit and outputs the position history information that has been recorded in the memory unit whenever the predetermined fluctuation occurs to the receiving condition of the radio wave. The wireless base station is a wireless base station which performs the location registration for wireless communication. The wireless base station information is information on the wireless base station at the time when the position information has been acquired.

A position search system according to yet another embodiment of the present invention includes the mobile information terminal mentioned above and a position search apparatus which acquires the position history information from the mobile information terminal and indicates the position history of the mobile information terminal so that it can be visually recognized based on the position history information.

A position search method according to another embodiment of the present invention includes a step which receives a radio wave from a wireless base station, a step which acquires the position information by GPS (global positioning system), a step which stores the position history information that is a set of the position information and the wireless base station information, a step which records the position history information to a memory unit whenever a predetermined fluctuation occurs to the receiving condition of the radio wave, a step which outputs the position history information recorded in the memory unit at the predetermined timing, a step which acquires the position history information from a mobile information terminal and a step which indicates the position history of the mobile information terminal so that it can be visually recognized based on the position history information. The wireless base station is a wireless base station which performs the location registration for the wireless communication. The wireless base station information is the information of the wireless base station at the time when the position information has been acquired.

While the invention has been particularly shown and described with reference to exemplary embodiments thereof, the invention is not limited to those embodiments. It will be understood by those of ordinary skill in the art that various changes in form and details may be made therein without departing from the spirit and scope of the present invention as defined by the claims.

This application is based upon and claims the benefit of priority from Japanese Patent Application Laid-Open No. 2010-285612, filed on Dec. 22, 2010, the disclosure of which is incorporated herein in its entirety by reference.

### EXPLANATION OF SYMBOLS

1 Position information acquisition unit
2 Wireless communication unit
3 Control unit
4 Memory unit
11 GPS antenna
12 GPS receiving unit
13 GPS signal processing unit
21 Antenna
22 Transmitting unit
23 Receiving unit
24 Signal processing unit
41 Position history information table
100 Mobile telephone terminal
200 Wireless network
201 Base station
202 Network
203 203-1,2,3 Radio wave
300 Position search apparatus
400 GPS satellite
401 401-1,2,3 Radio wave
1000 Mobile information terminal
1001 Position information acquisition means
1002 Wireless communication means
1003 Control means
1004 Storage means
2000 Wireless base station

1. A mobile information terminal comprising:
a wireless communication unit receiving a radio wave from a wireless base station and performing the location registration in said wireless base station;
a position information acquisition unit acquiring the position information;
a storage unit storing the position history information that is a set of said position information and the information on said wireless base station at the time when said position information has been acquired; and
a control unit recording said position history information to said storage unit whenever a predetermined fluctuation occurs to said radio wave reception condition.

2. The mobile information terminal according to claim 1, wherein said control unit records said position history information with enabling distinguishing that said position information has not been acquired when said position information acquisition unit cannot acquire said position information.

3. The mobile information terminal according to claim 1, wherein said position information includes the position information of the terminal itself and the acquisition time when said position information has been acquired, and the information of said wireless base station includes an identifier of said wireless base station of which said wireless communication unit has performed the location registration at said acquisition time and the reception level of the radio wave from said wireless base station.

4. The mobile information terminal according to claim 1, wherein said predetermined fluctuation includes a case that a fluctuation whose value is equal to or larger than a predetermined value has occurred to the reception level of said radio wave.

5. The mobile information terminal according to claim 1, wherein said predetermined fluctuation includes at least either one of a case that said wireless communication unit has completed the location registration to said wireless base station after said mobile information terminal being turn on and a case that said wireless communication unit has changed said wireless base station of the location registration.

6. The mobile information terminal according to claim 1, wherein said control unit outputs said position history information in a time sequence order.

7. The mobile information terminal according to claim 1, wherein said control unit outputs said position history information recorded in said storage at predetermined timing.

8. The mobile information terminal according to claim 1, wherein said control unit outputs said position history information when receiving a request from the outside.

9. The mobile information terminal according to claim 8, wherein said control unit outputs said position information in a case that said position information acquisition unit is possible to acquire said position information and outputs said position history information in a case that said position information acquisition unit is not possible to acquire said position information, when receiving said request.

10. A position search system comprising:
a mobile information terminal according to claim 1; and
a position search apparatus that acquires said position history information from said mobile information terminal and indicates the history of the position of said the mobile information terminal so that it is visually recognizable based on said position history information.

11. A position search method comprising the steps of:
receiving a radio wave from a wireless base station;
performing location registration in said wireless base station;
storing the position history information that is a set of said position information and the information of said wireless base station at the time when said position information has been acquired; and
recording said position history information in said storage means whenever a predetermined fluctuation occurs to said radio wave reception condition.

12. A recording medium recording a position search program that makes a computer execute the process of:
receiving a radio wave from a wireless base station;
performing the location registration in said wireless base station;
storing the position history information which is a set of said position information and the information on said wireless base station at the time when said position information has been acquired;
recording said position history information whenever a predetermined fluctuation occurs to said radio reception condition.
